(19) United States
(12) Patent Application Publication
(10) Pub. No.: US 2025/0363275 A1
(43) Pub. Date: Nov. 27, 2025

(54) Computer-Implemented Methods of Verifying a Processor Design Under Test, and Related Systems

(71) Applicant: Synopsys, Inc., Sunnyvale, CA (US)

(72) Inventors: Simon Davidmann, Oxford (GB); Aidan Dodds, Dunbar (GB); Lee Moore, Coventry (GB); James Kenney, Reading (GB)

(21) Appl. No.: 19/294,023

(22) Filed: Aug. 7, 2025

Related U.S. Application Data
(63) Continuation of application No. PCT/GB2023/051479, filed on Jun. 6, 2023.

(30) Foreign Application Priority Data
Feb. 7, 2023 (GB) 2301686.8
Apr. 27, 2023 (GB) 2306239.1

(51) Int. Cl. G06F 30/3308

(52) U.S. Cl. CPC G06F 30/3308

(57) ABSTRACT

This document concerns using of an Instruction Accurate reference model of a hardware micro-architecture as the reference to verify a central processing unit (CPU) hardware implementation, include the following. 1) A ‘mirror’ mechanism that enables the VC to maintain an exact copy of the internal architectural state of the DUT. 2) A ‘volatile’ algorithm that allows the VC/RM to adapt its internal state when that state is not architecturally defined, but micro-architecturally (e.g. implementation) defined. 3) A use of ‘speculative execution’ to explore different possible permissible paths through the execution state space of the RM especially in response to asynchronous events and hidden details of the DUT implementations. 4) A technique described as ‘convergence’ which allows the RM to adapt its internal state after a divergence in behaviour/state between the DUT and RM, allowing the verification process to continue.

### CROSS REFERENCE TO RELATED APPLICATIONS

This application is a continuation of PCT Application No. PCT/GB2023/051479, filed Jun. 6, 2023, entitled “Computer-Implemented Methods of Verifying a Processor Design Under Test, and Related Systems”, which application claims the benefit of GB Application No. 2301686.8, filed Feb. 7, 2023, and GB Application No. 2306239.1, filed Apr. 27, 2023, which are incorporated by reference in their entirety.

### BACKGROUND OF THE INVENTION

### 1. Field of the Invention

The field of the invention relates to computer-implemented methods of verifying a processor design under test, and to related systems.

### 2. Technical Background

There is a desire to test a computer processor design, by simulating a reference model. But the simulation may break down if the possibility of interrupts in the design under test is allowed. There is also a desire to test by performing simulation of a computer processor design even if the reference model and the processor design are not matched, to obtain a possible early indication of a problem with the processor design. There is also a desire to test a computer processor design, by simulating a reference model, in a way which includes rapid processing. There is also a desire to test a computer processor design, by simulating a reference model, even when volatile registers in the design under test are permitted.

### 3. Discussion of Related Art

US2016/0275220A1 and U.S. Ser. No. 11/574,087B2 disclose a method of running a plurality of simulated processors on a plurality of cores, in which simulation of the processors is performed in parallel on the plurality of cores. U.S. Pat. No. 8,417,508B2 discloses a multiprocessor development environment. U.S. Pat. No. 9,658,849B2 discloses a processor simulation environment.

EP2672388A1 and EP2672388B1 provide a method and a system for simulating multiple processors in parallel, and a scheduler. The scheduler maps debug interface information of a to-be-simulated processor requiring debugging onto the scheduler during parallel simulation of multiple processors, so that the scheduler is capable of debugging, by using a master thread, the to-be-simulated processor requiring debugging via a debug interface of the to-be-simulated processor requiring debugging pointed by the debug interface information, thereby implementing debugging during parallel simulation of multiple processors.

### SUMMARY OF THE INVENTION

According to a first aspect of the invention, there is provided a computer-implemented method of verifying a processor design under test with respect to a reference model, the method including the steps of:
(i) loading an instruction accurate reference model (RM) that accurately represents detailed behaviour of an instruction set architecture regarding its instructions, register state, state machines and asynchronous events, the RM including an executable program, data structures and contents, and setting the RM data structures and the RM contents to initial values;
(ii) loading a processor design under test (DUT), the DUT including an executable program;
(iii) loading a verification control, the verification control executable to step the DUT program and the RM program forward in time to execute instructions, and to keep the DUT program and the RM program in lock-step;
(iv) the verification control making an exact copy of the RM data structures and the RM contents in a mirror storage memory;
(v) the verification control stepping the DUT program by one instruction;
(vi) the verification control updating the mirror storage memory to update its values from the DUT;
(vii) the verification control stepping the RM program by one instruction;
(viii) the verification control performing a comparison of data in the mirror storage memory and data in the RM data structures and the RM contents, and storing any differences found in the comparison;
(ix) repeating steps (v) to (viii);
(x) reporting whether or not any differences were found in the comparisons in step (viii).

An advantage is that the mirror storage memory allows the DUT and the data in the RM data structures and the RM contents to be compared more readily than comparing with the DUT directly, because the mirror storage memory may be accessed more readily than accessing the DUT. An advantage is providing a quicker and more efficient, more cost effective solution to the problem of verifying computer (e.g. CPU) hardware implementations.

According to a second aspect of the invention, there is provided a computer-implemented method of verifying a processor design under test with respect to a reference model, the method including the steps of:
(i) loading an instruction accurate reference model (RM) that accurately represents detailed behaviour of an instruction set architecture regarding its instructions, register state, state machines and asynchronous events, the RM including an executable program, data structures and contents, and setting the RM data structures and the RM contents to initial values;
(ii) using a processor design under test (DUT) including an implementation in semiconductor circuitry (e.g. silicon semiconductor circuitry, e.g. a field-programmable gate array (FPGA)), the DUT including an executable program;
(iii) loading a verification control, the verification control executable to step the DUT program and the RM program forward in time to execute instructions, and to keep the DUT program and the RM program in lock-step;
(iv) the verification control making an exact copy of the RM data structures and the RM contents in a mirror storage memory;
(v) the verification control stepping the DUT program by one instruction;
(vi) the verification control updating the mirror storage memory to update its values from the DUT;
(vii) the verification control stepping the RM program by one instruction;
(viii) the verification control performing a comparison of data in the mirror storage memory and data in the RM data structures and the RM contents, and storing any differences found in the comparison;
(ix) repeating steps (v) to (viii);
(x) reporting whether or not any differences were found in the comparisons in step (viii).

An advantage is that the mirror storage memory allows the DUT and the data in the RM data structures and the RM contents to be compared more readily than comparing with the DUT directly, because the mirror storage memory may be accessed more readily than accessing the DUT. An advantage is providing a quicker and more efficient, more cost effective solution to the problem of verifying computer (e.g. CPU) hardware implementations.

The method may be one wherein step (ix) includes repeating steps (v) to (viii) until all instructions in the DUT program and in the RM program have been stepped through.

The method may be one in which the Instruction Accurate model only models those operations as defined and visible in an Instruction Set Architecture (ISA), the architectural level, and does not concern itself with the detailed micro-operations that make up the Instruction Set Architecture (ISA).

The method may be one in which the ISA is a standard, meaning that different implementations of the ISA should all produce the same results when executing programs made up of instructions defined in that ISA.

The method may be one in which the reference model can be configured to match any choices made by the designers in implementing any implementation choices of the ISA definition.

The method may be one wherein respective RM and DUT software programs written using instructions and registers of the ISA are compiled into object code binaries, and loaded into respective memories, and respectively presented to the reference model (RM) and to the DUT, then executed.

The method may be one wherein when an instruction executes, the instruction may not complete (‘retirement’) as there may be one or more events (such as an external interrupt) that force the DUT and the RM to execute alternative instructions (such as an interrupt handler sub routine)—and the verification control including Verification Components (VC) monitors that the DUT and RM remain in lock-step and that while executing the same instructions and events, both exhibit exactly the same behaviour as defined in the specification of the ISA.

The method may be one wherein a constructor program 200 takes data from an ISA configuration file 210 and a core specific configuration file 220 and creates the internal data structures for the reference model 230.

The method may be one wherein the ISA configuration file 210 contains base model information to configure a generic model.

The method may be one wherein data from the ISA configuration file and the core specific file is used by the constructor program to determine what is created in the reference model data structure 230 and to initialize values.

The method may be one wherein a reference model does not model a detailed micro-architectural implementation but is an instruction accurate representation.

The method may be one wherein the Design Under Test (DUT) is written in a hardware description language, such as Verilog, at the gate or register-transfer level (RTL) level of abstraction, for use in simulation.

The method may be one including use of a tracer interface from the DUT, configured to inspect a DUT state.

The method may be one wherein the verification control includes Verification Components (VC) that control, record, manage, measure, check, and report the operation of verification execution runs.

The method may be one including the verification control executing to clock and to step the DUT and RM forward in time to execute the next instructions, and to keep the RM and DUT in lock-step.

The method may be one wherein the DUT includes a respective memory.

The method may be one wherein the RM includes a respective memory.

The method may be one wherein the execution of instructions by the DUT and the RM is controlled by the verification control (e.g. the Verification Components (VC)) in such a way that the DUT and the RM complete execution of their programs one instruction at a time.

The method may be one wherein when both the DUT and RM have executed one instruction to retirement (i.e. they are in lock-step) then the verification control (e.g. the Verification Components (VC)) compares the internal information in the RM with the DUT, by gathering data from the DUT's tracer, before reporting any differences.

The method may be one wherein when the tracer of the DUT reports that the DUT has changed its state, the values in the mirror are updated accordingly, performing checks that the mirror has the correct locations for storing the DUT state and ensuring the state is updated with permissible values.

The method may be one wherein creation of internal data structures starts by the creation of the reference model data structures.

The method may be one wherein after the reference model data structure has been created and its contents set to initial values 300, the reference model data structure and its contents are duplicated, using the duplicator program 310, which creates an exact ‘mirror’ copy 320 with the same structure and contents.

The method may be one wherein the DUT includes data structures to hold values and code to perform an operational behaviour of a device.

The method may be one wherein the verification control system 420 connects 430 to the DUT 400, 410 to allow control such as instruction execution stepping.

The method may be one wherein when the DUT 400, 410 is stepped it executes its behaviour such as instruction execution or interrupt/debug processing and then the verification control 420 instructs the mirror 440 to update its values 450.

The method may be one wherein the verification control 420 then steps 490 the reference model 460, 470 to execute behaviour such as instruction execution or interrupt/debug processing and then the verification control 420 performs a comparison 480 of the data in the mirror 450 and the reference model 460.

The method may be one including a computer-implemented method of the RM adapting its internal state when that state is not architecturally defined, but is micro-architecturally defined, the method including the step of, in step (v), the verification control steps the DUT program by one instruction in which a read access is performed to a volatile register or to a volatile memory location, and in step (vii) the RM data structures and the RM contents are set such that a result of the instruction in step (vii) corresponds to a result of the read access in step (v), using a corresponding result entered into the mirror storage memory in step (vi). An advantage is that the method is able to deal successfully with the case of volatile registers or volatile memory locations.

The method may be one wherein in step (vii), an input register or an input memory location is read, and the verification control checks if the input register, or the input memory location, is declared as being volatile, and if the input register or the input memory location is declared as being volatile, then the value in the mirror storage memory corresponding to the output register or the output memory location is stored as an output value in the RM data structures and the RM contents. An advantage is that the method is able to deal successfully with the case of volatile registers or volatile memory locations.

The method may be one wherein in step (vii), an input register or an input memory location is read, and the verification control checks if the input register or the input memory location is declared as being volatile, and if the input register or the input memory location is declared as not being volatile, then a calculated value of an output register based on the input register, or a calculated value of an output memory location based on the input memory location, is stored as an output value in the RM data structures and the RM contents.

According to a third aspect of the invention, there is provided a system configured to perform a method of any aspect of the first or second aspects of the invention.

According to a fourth aspect of the invention, there is provided a computer-implemented method of verifying a processor design under test with respect to a reference model, the method including speculative execution of the reference model, the method including the steps of:
(i) loading an instruction accurate reference model (RM) that accurately represents detailed behaviour of an instruction set architecture regarding its instructions, register state, state machines and asynchronous events, the RM including an executable program, data structures and contents, and setting the RM data structures and the RM contents to initial values;
(ii) loading a processor design under test (DUT), the DUT including an executable program;
(iii) loading a verification control, the verification control executable to step the DUT program and the RM program forward in time to execute instructions, and to keep the DUT program and the RM program in lock-step;
(iv) the verification control making an exact copy of the RM data structures and the RM contents in a mirror storage memory;
(v) the verification control stepping the DUT program by one instruction;
(vi) the verification control updating the mirror storage memory to update its values from the DUT;
(vii) the verification control stepping the RM program by one instruction in an instruction time, wherein if multiple events occur in the instruction time, the verification control advances the RM a plurality of times, speculatively, exploring all architecturally permissible outcomes, until a sequence in the RM is found such that the RM data structures and the RM contents converge to match the mirror storage memory values updated using the values from the DUT in step (vi), or until all outcomes have been exhaustively evaluated and these outcomes are not such that the RM data structures and the RM contents converge to match the mirror storage memory values updated using the values from the DUT in step (vi);
(viii) the verification control performing a comparison of data in the mirror storage memory and data in the RM data structures and the RM contents, and storing any differences found in the comparison;
(ix) repeating steps (v) to (viii);
(x) reporting whether or not any differences were found in the comparisons in step (viii). An advantage is that the verification can be performed, even if multiple events occur in an instruction time.

According to a fifth aspect of the invention, there is provided a computer-implemented method of verifying a processor design under test with respect to a reference model, the method including speculative execution of the reference model, the method including the steps of:
(i) loading an instruction accurate reference model (RM) that accurately represents detailed behaviour of an instruction set architecture regarding its instructions, register state, state machines and asynchronous events, the RM including an executable program, data structures and contents, and setting the RM data structures and the RM contents to initial values;
(ii) using a processor design under test (DUT) including an implementation in semiconductor circuitry (e.g. silicon semiconductor circuitry, e.g. a field-programmable gate array (FPGA)), the DUT including an executable program;
(iii) loading a verification control, the verification control executable to step the DUT program and the RM program forward in time to execute instructions, and to keep the DUT program and the RM program in lock-step;
(iv) the verification control making an exact copy of the RM data structures and the RM contents in a mirror storage memory;
(v) the verification control stepping the DUT program by one instruction;
(vi) the verification control updating the mirror storage memory to update its values from the DUT;
(vii) the verification control stepping the RM program by one instruction in an instruction time, wherein if multiple events occur in the instruction time, the verification control advances the RM a plurality of times, speculatively, exploring all architecturally permissible outcomes, until a sequence in the RM is found such that the RM data structures and the RM contents converge to match the mirror storage memory values updated using the values from the DUT in step (vi), or until all outcomes have been exhaustively evaluated and these outcomes are not such that the RM data structures and the RM contents converge to match the mirror storage memory values updated using the values from the DUT in step (vi);
(viii) the verification control performing a comparison of data in the mirror storage memory and data in the RM data structures and the RM contents, and storing any differences found in the comparison;
(ix) repeating steps (v) to (viii);
(x) reporting whether or not any differences were found in the comparisons in step (viii). An advantage is that the verification can be performed, even if multiple events occur in an instruction time.

The method may be one wherein there is no single correct order of the multiple events, but instead there are multiple (e.g. many) possible alternative sequences of events, all permissible as defined in an Instruction Set Architecture (ISA) specification.

The method may be one wherein the verification control including Verification Components (VC) and the RM validate that the micro-architecture choices are permissible, as defined in the ISA specification.

The method may be one wherein the method includes verifying processors by using lock-step comparison of DUT and RM to verify the behaviours when asynchronous events occur.

The method may be one in which an instruction is split into two, three or more stages (e.g. pipeline stages) of execution: fetch, decode, execute, writeback.

The method may be one including using an instruction accurate reference model in which each instruction is executed as one atomic operation.

The method may be one wherein when multiple events occur within one instruction in the implementation's pipeline stages these intra instruction events are communicated in a correct order to the RM, so that the RM advances to the same state as the DUT.

The method may be one wherein the RM checks the order implemented by the hardware implementation is permissible and then follows the order implemented by the hardware implementation.

The method may be one wherein at the point of multiple events occurring in the same instruction time, the verification control including Verification Components (VC) performs a localized search including advancing the RM multiple (e.g many) times, speculatively, exploring all architecturally permissible outcomes (e.g. based on state, specification, and event sequencing and interleaving) until a sequence is found such that the RM converges to the DUT state, and then continuing the verification process with the next event, or halting the localized search after all outcomes have been exhaustively evaluated and resulting in verification match failure, and then continuing with the verification process with the next event. An advantage is that the verification can be performed, even if multiple events occur in an instruction time.

The method may be one wherein a speculative synchronization algorithm provides the RM with only two potential choices: either step the RM model 710, or apply a net/wire change event (e.g. an Interrupt) to RM model 720.

The method may be one including continuing down each of these choices/paths—making further choices until reaching a leaf/terminal node in the execution tree.

The method may be one wherein when identifying an instruction retirement after stepping the model, this is considered a terminal node, at which point a comparison can take place.

The method may be one including comparing 760 the RM state vs the DUT/Mirror state to confirm that the RM and DUT/Mirror are in synchronization and have all the same values, i.e., the RM verifies the DUT state is correct.

The method may be one including if the DUT/Mirror state matches the RM: selecting that path as the correct sequence of operations, discarding all options, and replaying the exact sequence of steps to reach that path down the tree; then leaving the RM and DUT/Mirror in compared equal state.

The method may be one including, if there is no match, continuing.

The method may be one wherein if there is a failure to find a match and all possible paths are exhausted and if all comparisons fail, then the DUT state is not considered permissible and an error is reported.

The method may be one including a method of any aspect of the first or second aspects of the invention.

According to a sixth aspect of the invention, there is provided a system configured to perform a method of any aspect of the fourth or fifth aspects of the invention.

According to a seventh aspect of the invention, there is provided a computer-implemented method of verifying a processor design under test with respect to a reference model, in which the verification continues even in the event of a verification failure, the method including the steps of:
(i) loading an instruction accurate reference model (RM) that accurately represents detailed behaviour of an instruction set architecture regarding its instructions, register state, state machines and asynchronous events, the RM including an executable program, data structures and contents, and setting the RM data structures and the RM contents to initial values;
(ii) loading a processor design under test (DUT), the DUT including an executable program;
(iii) loading a verification control, the verification control executable to step the DUT program and the RM program forward in time to execute instructions, and to keep the DUT program and the RM program in lock-step;
(iv) the verification control making an exact copy of the RM data structures and the RM contents in a mirror storage memory;
(v) the verification control stepping the DUT program by one instruction;
(vi) the verification control updating the mirror storage memory to update its values from the DUT;
(vii) the verification control stepping the RM program by one instruction;
(viii) the verification control performing a first comparison of data in the mirror storage memory and data in the RM data structures and the RM contents, and storing any differences found in the first comparison as a verification failure, and where any differences are found in the first comparison, the RM data structures and the RM contents are updated with values from the mirror storage memory such that a second comparison of data in the mirror storage memory and data in the updated RM data structures and the updated RM contents would produce no differences;
(ix) repeating steps (v) to (viii);
(x) reporting whether or not any differences were found in the comparisons in step (viii). An advantage is that verification testing can continue, even if a verification failure is found. An advantage is that verification testing can continue, even if a verification failure is found, when the DUT and RM are not the same, such as is often due to the speed of developing the DUT and RM as the design project evolves.

According to an eighth aspect of the invention, there is provided a computer-implemented method of verifying a processor design under test with respect to a reference model, in which the verification continues even in the event of a verification failure, the method including the steps of:
(i) loading an instruction accurate reference model (RM) that accurately represents detailed behaviour of an instruction set architecture regarding its instructions, register state, state machines and asynchronous events, the RM including an executable program, data structures and contents, and setting the RM data structures and the RM contents to initial values;
(ii) using a processor design under test (DUT) including an implementation in semiconductor circuitry (e.g. silicon semiconductor circuitry, e.g. a field-programmable gate array (FPGA)), the DUT including an executable program;
(iii) loading a verification control, the verification control executable to step the DUT program and the RM program forward in time to execute instructions, and to keep the DUT program and the RM program in lock-step;
(iv) the verification control making an exact copy of the RM data structures and the RM contents in a mirror storage memory;
(v) the verification control stepping the DUT program by one instruction;
(vi) the verification control updating the mirror storage memory to update its values from the DUT;
(vii) the verification control stepping the RM program by one instruction;
(viii) the verification control performing a first comparison of data in the mirror storage memory and data in the RM data structures and the RM contents, and storing any differences found in the first comparison as a verification failure, and where any differences are found in the first comparison, the RM data structures and the RM contents are updated with values from the mirror storage memory such that a second comparison of data in the mirror storage memory and data in the updated RM data structures and the updated RM contents would produce no differences;
(ix) repeating steps (v) to (viii);
(x) reporting whether or not any differences were found in the comparisons in step (viii). An advantage is that verification testing can continue, even if a verification failure is found. An advantage is that verification testing can continue, even if a verification failure is found, when the DUT and RM are not the same, such as is often due to the speed of developing the DUT and RM as the design project evolves.

The method may be one wherein if any differences are found in the first comparison, a verification comparison failure (i.e. the divergence in program flow) is flagged and then by using values of the state of the DUT, the state of the RM is updated, ie the RM state is forced, and thus the program continues and re-converges, in which the mirror storage memory is used for the values of the state of the DUT.

The method may be one wherein if any differences are found in the first comparison, the RM data structures and the RM contents are updated with values from the mirror storage memory such that a second comparison of data in the mirror storage memory and data in the updated RM data structures and the updated RM contents would produce no differences, then the RM takes on 960 the full state of the DUT/Mirror 970, reports the differences found in the first comparison, and the method continues as if everything had compared successfully.

The method may be one wherein the step in which where any differences are found in the first comparison, the RM data structures and the RM contents are updated with values from the mirror storage memory such that a second comparison of data in the mirror storage memory and data in the updated RM data structures and the updated RM contents would produce no differences, is provided as a selectable option.

The method may be one including a method of any aspect of the first or second aspects of the invention.

According to a ninth aspect of the invention, there is provided a system configured to perform a method of any aspect of the seventh or eighth aspects of the invention.

According to a tenth aspect of the invention, there is provided a computer program product executable on a processor to perform a computer-implemented method of any aspect of the first, second, fourth, fifth, seventh or eighth aspects of the invention.

According to an eleventh aspect of the invention, there is provided a computer-implemented method of using of an Instruction Accurate reference model of a hardware micro-architecture as the reference to verify a central processing unit (CPU) hardware implementation. An advantage is providing a quicker and more efficient, more cost effective solution to the problem of verifying computer (e.g. CPU) hardware implementations.

The method may include a computer-implemented method of any aspect of the first, second, fourth, fifth, seventh or eighth aspects of the invention.

According to a twelfth aspect of the invention, there is provided a system configured to perform a method of any aspect of the eleventh aspect of the invention.

Aspects of the invention may be combined.

### BRIEF DESCRIPTION OF THE DRAWINGS

Aspects of the invention will now be described, by way of example(s), with reference to the following Figures, in which:

FIG. 1 shows an example of an overall structure of an example of lock-step verification.

FIG. 2 shows an example of creating data storage for a reference model.

FIG. 3 shows an example of creating data storage for a mirror.

FIG. 4 shows an example of an overview of, and basic operation of, verification components.

FIG. 5 shows an example behaviour of volatile register operation.

FIG. 6 shows an example of multiple interrupts occurring during one instruction.

FIG. 7 shows a speculative execution and synchronization state diagram, in an example.

FIG. 8 shows an example of a speculative execution and synchronization algorithm operation.

FIG. 9 shows an example of a re-convergence algorithm.

### DETAILED DESCRIPTION

We describe verifying Central Processing Units (CPUs) using simulation and instruction accurate reference models. We describe techniques to use an instruction accurate architectural reference model to verify processor microarchitecture operation.

In the world of hardware verification, reference models are used to check that an implementation matches the reference. To do this requires some form of step by step comparison of the reference with the design. We have developed several techniques that enable this lock-step verification between a hardware design implementation and an abstract instruction accurate model.

We consider Instruction Accurate models of Central Processing Units (CPUs).

The purpose of a Central Processing Unit (CPU) is to fetch, decode, and execute instructions from a memory system and calculate results. The definition and operation of these instructions are defined in the CPU's Instruction Set Architecture (ISA) definition. Software is then created to run on this ISA and thus on any CPU that implements the ISA.

In hardware implementations of a CPU whose operations conform to a specific ISA, these operations are split into many micro-architectural smaller operations operating sequentially and in parallel. There is often the breaking down of the operation into a pipeline of smaller operations and there may be several parallel pipelines and several smaller execution blocks. These micro-architectural blocks and operations are created to perform the execution of software that conforms to the ISA, meeting specific implementation target goals such as fastest execution for a given clock speed or least power usage etc. A key thing is that even though there may be hundreds of micro-operations and many parallel pipelines that may even execute operations in different order from run to run and instruction to instruction, the software is seen as executing in the way defined in the ISA specification. An advanced CPU hardware implementation may execute hundreds of operations and instructions in parallel yet still maintain the software execution in a correct order.

A software model of a CPU is software which when executed on a host computer such as a personal computer (PC) behaves in the same way as the hardware of the CPU. CPU Models can be cycle accurate or instruction accurate.

A cycle accurate model has behaviour matching the micro-architecture in that it can model and execute all the micro-operations as implemented in the hardware. The cycle accurate model is very detailed, and runs very slowly due to there being so many micro-architectural operations to execute in the model. It is also very hard to model exactly the predicted behaviours implemented in the micro-architecture.

An Instruction Accurate model only models those operations as defined and visible in the ISA—the architectural level, and does not concern itself with the detailed micro-operations that make up the ISA. An Instruction Accurate model is traditionally used to test the operation of software that conforms to the ISA and because it is an abstraction of the detailed micro-architecture, it runs hundreds of times, to thousands of times, faster than a cycle accurate simulator. Instruction Accurate simulators are commonly used in modern development projects and are often integrated into a software wrapper and called an Instruction Set Simulator (ISS).

The verification of the hardware micro-architecture of a CPU is often completed by using a Cycle Accurate model and simulator comparing operation with the hardware implementation and is very slow, very time consuming and very hard to complete successfully—and it is very hard to get the Cycle Accurate model to be correct to the CPU hardware being verified.

Here we focus on the techniques we have created to make use of an Instruction Accurate abstract model of the hardware micro-architecture as the reference for verification of the CPU hardware implementation. These techniques provide a quicker and more efficient, more cost effective solution to the problem of verifying computer hardware implementations.

The development of Instruction Set Architecture (ISA) definitions for computers allows engineers to develop their own processor designs for implementation in silicon such that they can execute programs using these ISAs.

If the ISA is in any way a standard (meaning that different implementations of the ISA should all produce the same results when executing programs made up of instructions defined in that ISA) then it is essential that the implementations are verified to comply with the ISA definitions.

There are many challenges in verifying that an implementation complies with the ISA specification and this document explains several methods that we have developed to verify these processors, by making use of a configurable reference instruction accurate model.

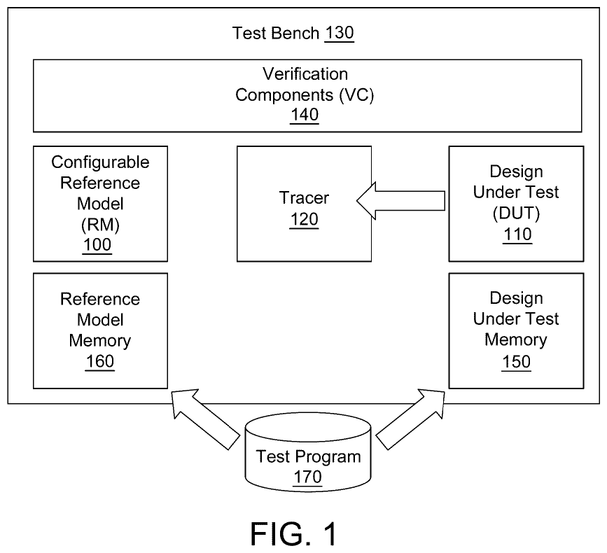

FIG. 1 shows an example of an overall architecture.

In an example, the basis of the verification approach is that there are several components:
a) an executable reference model (RM) 100 that accurately represents the detailed behaviour of the ISA in terms of its instructions, register state, state machines, and asynchronous events. This reference model can be configured to match any choices made by the designers in implementing any implementation choices of the ISA definition. This reference model can be configured to match any choices made by the designers in implementing any optional parts of the ISA definition. This reference model does not model the detailed micro-architectural implementation but is an instruction accurate representation.
b) the Design Under Test (DUT) 110 implemented in silicon, or written in a hardware description language, such as Verilog, at the gate or register-transfer level (RTL) level of abstraction for use in simulation.
c) a tracer interface 120 from the DUT up to the test bench, providing inspection of the DUT state.
d) the Test Bench 130 including Verification Components (VC) 140 that control, record, manage, measure, check, and report the operation of verification execution runs. This clocks/steps the DUT and RM forward in time to execute the next instructions, and keeps the RM and DUT in lock-step.
e) there are also other components such as memories for DUT 150, and RM 160 executable software programs 170 that are also needed for the verification process.

Regarding asynchronous events, these may be considered to be historical in nature. A queue of events may be kept in order to replay all those events to observe the potential path outcomes. The queue may be maintained to a programmable depth, which is directly proportional to the potential search space. The event queues may be defined as in-order (a single queue), or as interleaving-order (multiple queues).

In software engineering, tracing involves a specialized use of logging to record information about a program's execution. This information may be used by programmers for debugging purposes. Software tracing may provide developers with information useful for debugging. This information may be used during development cycles.

Software programs written using the instructions, registers etc of the ISA are compiled into object code binaries, and loaded in memories and presented to the reference model (RM) and presented to the DUT, then executed.

The execution of instructions by the DUT and the RM is controlled by the VC in such a way that the DUT and the RM complete execution of their programs one instruction at a time. When both the DUT and RM have executed one instruction to retirement (i.e. they are in lock-step) then the VC compares the internal information in the RM with the DUT, by gathering data from the DUT's tracer, before reporting any differences.

When an instruction executes—it may not complete (retirement’) as there may be one or more events (such as an external interrupt) that force the DUT and the RM to execute alternative instructions (such as an interrupt handler sub routine)—and again the VC monitors or ensures that the DUT and RM remain in lock-step and that while executing the same instructions and events, both exhibit exactly the same behaviour as defined in the specification of the ISA.

The subjects of this document include the mechanisms of this accurate stepping, executing events, recording internal states and comparing. Stepping may be considered to be executing an instruction until an instruction retires.

A key thing for lock-step verification is keeping an instruction accurate reference model (RM) in synchronization with a detailed pipelined processor (DUT). There can be multiple events that could occur during an instruction's execution and a challenge is to accurately predict what sequence of events will be acted upon in the DUT. For example, if there are four interrupt signals that all become active whilst one instruction is in flight, the DUT will proceed in one of the possible/permissible N different sequences of the four possible interrupts. A challenge is having the RM correctly evaluate the input conditions to exhibit the same behaviour.

If the RM and DUT get out of synchronization, the verification process has to stop as the results of the verification will not be correct or useful. Out of synchronization verification will provide false positive or false negative results. Verification is only possible and accurate if the RM and DUT stay in synchronization.

The subjects of this document include four main items.
1) A ‘mirror’ mechanism that enables the VC to maintain an exact copy of the internal architectural state of the DUT.
2) A ‘volatile’ algorithm that allows the VC/RM to adapt its internal state when that state is not architecturally defined, but micro-architecturally (e.g. implementation) defined.
3) A use of ‘speculative execution’ to explore different possible permissible paths through the execution state space of the RM especially in response to asynchronous events and hidden details of the DUT implementations.
4) A technique described as ‘convergence’ which allows the RM to adapt its internal state after a divergence in behaviour/state between the DUT and RM, allowing the verification process to continue.

We describe maintaining a configurable mirror of the DUT internal state.

Most ISAs are highly configurable and different configuration options change the behaviour of instructions and events, but can also impose changes to the registers that maintain the state.

To validate the DUT and RM at each event/stepped instruction and after synchronization, a comparison is made between the DUT state and the RM state. Any misconfiguration of the variables being compared could lead to bugs being missed by the verification process.

To make comparison easy and ensure it is correctly configured we developed the technique of having a third storage area, the mirror’. We are not aware of any other simulation technique being used in processor verification using lock-step techniques that adopts this approach.

The mirror is an exact copy of the configured RM so that when the tracer of the DUT reports that it has changed its state, the values in the mirror are updated accordingly, performing checks that the mirror has the correct locations for storing the DUT state and ensuring the state is updated with permissible values—without any chance of mis-configuration. This improves the confidence in the quality of the verification.

In an example, the creation of the internal data structures starts by the creation of the reference model data structures. The constructor program 200 takes data from the ISA configuration file 210 and the core specific configuration file 220 and creates the internal data structures for the reference model 230.

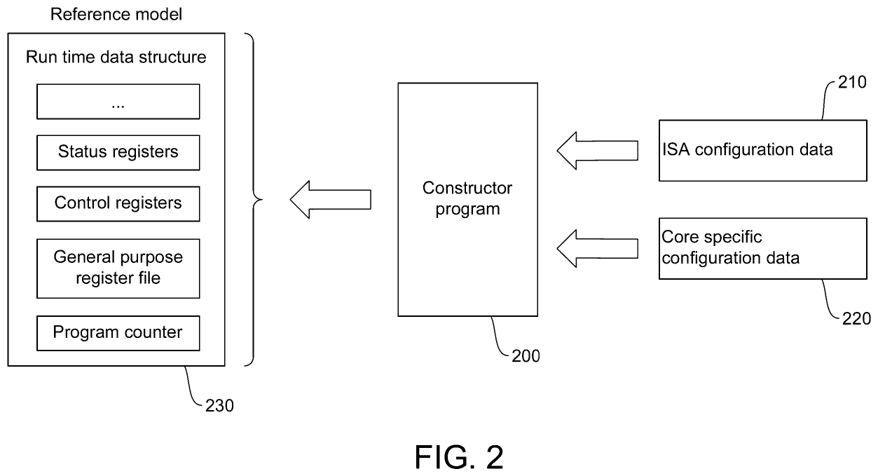

The ISA configuration file 210 contains base model information to configure a generic model. The core specific file configuration 220 contains any core specific data. The data from these two files is used by the constructor to determine what is created in the reference model data structure 230 and to initialize values. A reference model example includes a run time data structure including status registers, control registers, a general purpose register file and a program counter. An example is shown in FIG. 2.

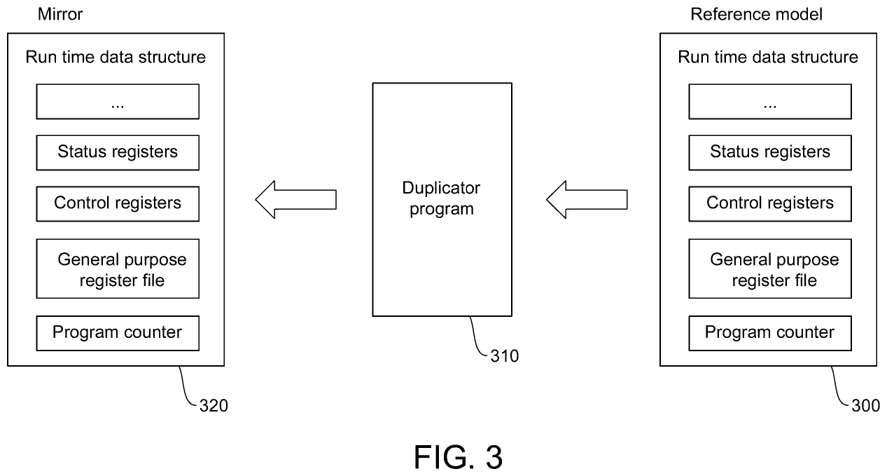

In an example, when creating data storage for a mirror, after the reference model data structure has been created and its contents set to initial values 300, it is duplicated, in the duplicator program 310, which creates an exact ‘mirror’ copy 320 with the same structure and contents. A reference model example includes a run time data structure including status registers, control registers, a general purpose register file and a program counter. A mirror example includes a run time data structure including status registers, control registers, a general purpose register file and a program counter. FIG. 3 shows an example of creating data storage for a mirror.

The verification system has an overall structure. In an example, the DUT 400 has both data structures to hold all the values but also code to perform the operational behaviour 410 of the device. A DUT example includes a run time data structure including status registers, control registers, a general purpose register file and a program counter. In an example, DUT behaviour code is also provided.

The verification control system 420 connects 430 to the DUT 400, 410 to allow control such as instruction execution stepping. When the DUT 400, 410 is stepped it executes its behaviour such as instruction execution or interrupt/debug processing and then the verification control 420 instructs the mirror 440 to update its values 450. A mirror example includes a run time data structure including status registers, control registers, a general purpose register file and a program counter.

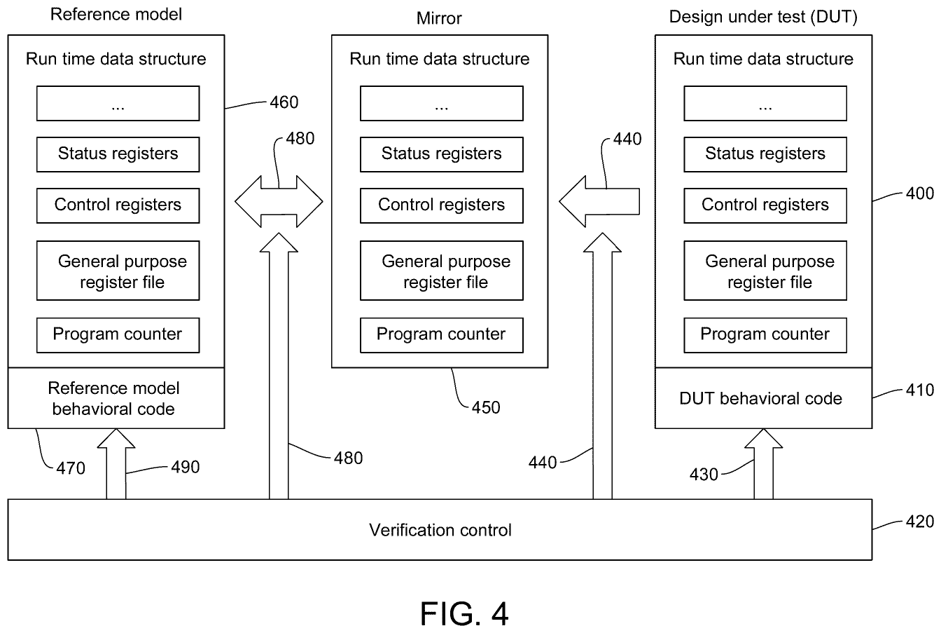

The verification control 420 then steps 490 the reference model 460, 470 to execute behaviour such as instruction execution or interrupt/debug processing and then the verification control 420 performs a comparison 480 of the data in the mirror 450 and the reference model 460. A reference model example includes a run time data structure including status registers, control registers, a general purpose register file and a program counter. In an example, reference model behaviour code is also provided. FIG. 4 shows an example of an overview of, and basic operation of, verification components.

We describe Volatile registers, and volatile address range (e.g. memory) regions.

There are many registers in an ISA definition that have no architectural definition of their content and behaviours. Such registers are ‘implementation’ choices. For example, performance counter registers—different for each implementation. These registers are often defined in architectural models, but with no defined behaviour.

Also, there are often regions of memory where the values cannot be predicted—for example where there is a behavioural component sampling real world events e.g., memory mapped input/output (I/O) (for example a universal asynchronous receiver-transmitter (UART)). The values read from those locations cannot be predicted by the reference model. These are termed ‘ non-idempotent’ locations/regions.

There is also the issue of where the memory is changed from outside the processor, e.g., from Direct memory access (DMA) components in the platform where the processor is not aware of the memory being changed.

In prior verification solutions these phenomena would just be ignored, thereby restricting the types of programs that could be used for verification, and limiting some of the verification that could be performed related to these implementation defined registers and memory regions.

We have developed a technique to ‘teach’ the RM what the results of these behaviours is such that programs executing on the RM perform exactly the same as those on DUT, and hence lock step synchronized verification can take place.

The algorithm is: When the DUT executes an instruction that performs a read access to a volatile register/memory, the RM will ensure that the result of the instruction matches the DUT using the result entered into the mirror.

In an example behaviour of volatile register operation, the reference model 500 executes an instruction 510 and then checks to see if the input register is declared volatile 520. If it is not declared volatile 530, the calculated value of the output register 540 is taken from the execution behavior in the reference model 500 and saved in the reference model's register file 550. If the input register 520 is volatile, the value from the mirror 560 is taken as the value stored in the reference model's register file 550. A reference model example includes a run time data structure including status registers, control registers, a general purpose register file and a program counter. In an example, reference model behaviour code is also provided. A mirror example includes a run time data structure including status registers, control registers, a general purpose register file and a program counter.

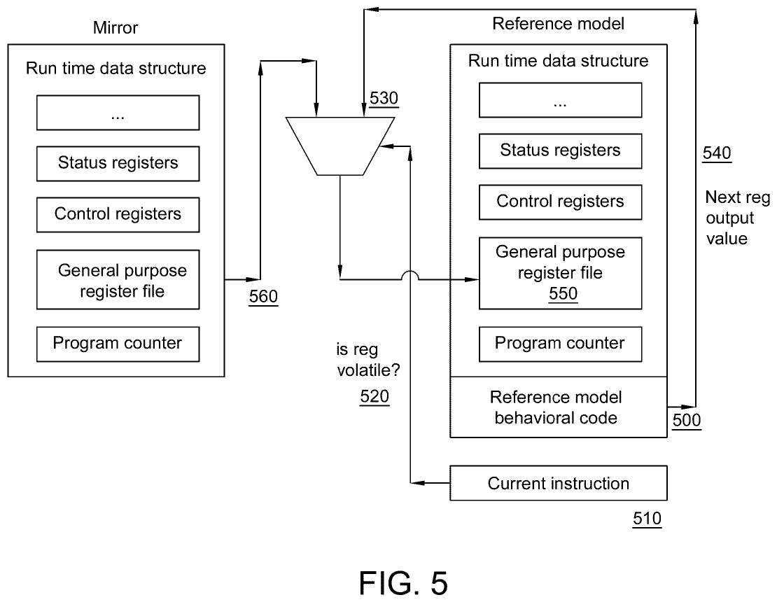

FIG. 5 shows an example behaviour of volatile register operation; FIG. 5 shows an example of the control and behaviour of registers declared as ‘volatile’

### Speculative Execution & Synchronization

We have developed a speculative execution synchronization technology for processor microarchitecture verification using abstract instruction accurate architecturally correct reference models.

We believe that currently no automated systems or methods for verifying processors by using lock-step comparison of DUT and RM to verify the behaviours when asynchronous events occur are known. Our technique of speculative execution verification provides automated systems or methods for verifying processors by using lock-step comparison of DUT and RM to verify the behaviours when asynchronous events occur.

In an implementation (e.g. a microarchitecture), an instruction will be split into two, three or more stages (e.g. pipeline stages) of execution: fetch, decode, execute, writeback. In an instruction accurate reference model each instruction is executed as one atomic operation. When there are multiple events that occur within one instruction in the implementation's pipeline stages a challenge is communicating these intra instruction events in a correct order to the RM, so that the RM advances to the same state as the DUT. In fact, there is no single ‘correct’ order—there are many possible alternative sequences of events—all permissible as defined in the ISA specification, so a challenge is ensuring the RM checks the order implemented by the hardware implementation is permissible and then follows the order implemented by the hardware implementation.

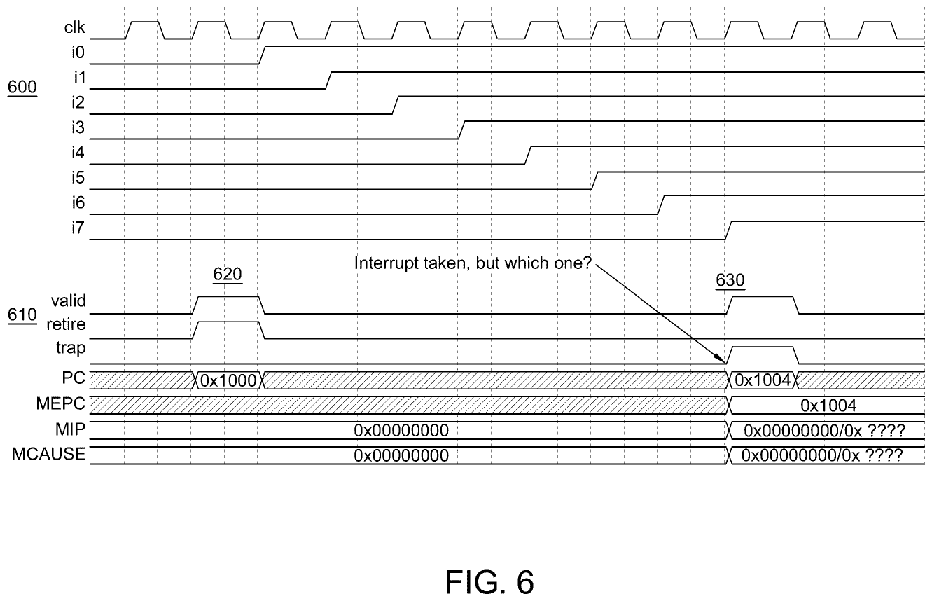

An example of choosing an event sequence is shown in FIG. 6. FIG. 6 shows a waveform diagram where the top part 600 shows interrupt pins and their values over time and rising (i.e. becoming active) at different clock cycles.

In FIG. 6, the bottom part 610 shows values of several control registers and one instruction retires at 620 and another at 630. There are eight interrupts occurring i0-i7 in the time of that one instruction and a challenge is determining which interrupt is actually taken by the DUT. The hardware micro-architecture can choose the order to process the interrupts. The VC and RM need to validate that the micro-architecture choices are permissible, as defined in the ISA specification.

The technique we have developed is:

At the point of multiple events occurring in the same instruction time, for the VC to advance the RM many times, speculatively, exploring all architecturally permissible outcomes (e.g. based on state and specification, and sequencing) until a sequence is found such that the RM converges to the DUT state and then continuing the verification process with the next event, or by halting after all outcomes have been exhaustively evaluated and resulting in verification match failure.

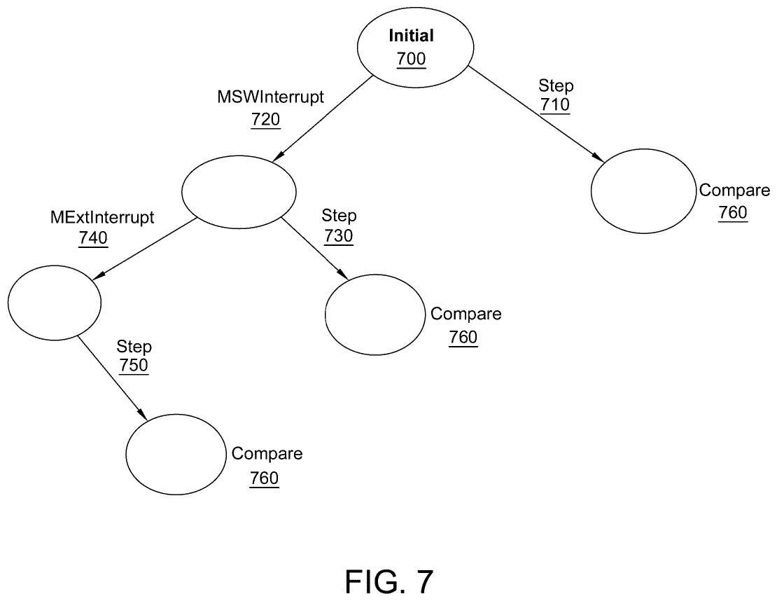

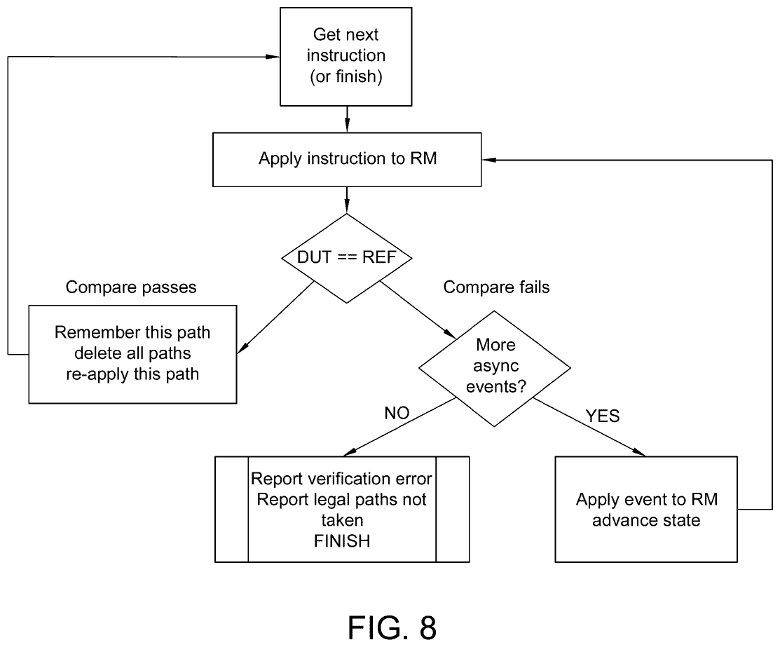

FIG. 7 is an example diagram of the states an algorithm takes in the speculative execution of an example of two simultaneous events. FIG. 8 shows an example of a speculative execution and synchronization algorithm.

FIG. 7 is an example state diagram of the operation of our verification speculative execution algorithm to determine which interrupt should be taken by the RM when two interrupts (MSWInterrupt, and MExtInterrupt) are present at the time of one instruction.

The algorithm starts in an initial state 700.

Referring by way of example to FIG. 4, which shows an example of operation of verification components, the Verification Control steps the DUT so it has advanced and communicated changes to RM/Mirror.

As the DUT executes the step, the micro-architecture pipeline design and different async events occurring leads to the situation that there may be several permissible possible outcomes as to how the execution proceeds.

The question is how does the RM decide that the DUT has followed a correct execution path and a correct route through all the permissible possibilities?

Our speculative synchronization algorithm provides the RM with only two potential choices at this point:

Either step the RM model 710; or
apply a net/wire change event (e.g. an Interrupt) to RM model 720.

The algorithm then continues down each of these choices/paths—making further choices until the algorithm reaches a leaf/terminal node in the execution tree. So, at any particular state in the graph the algorithm moves to another state by either stepping the RM or applying an event to the RM.

For example, in FIG. 7 there are these paths/states from the initial state 700:
Step 710;
Net 720, Step 730;
Net 720, Net 740, Step 750.

When the algorithm identifies an instruction retirement after stepping the model, this is considered a terminal node, at which point a comparison can take place. The algorithm then compares 760 the RM state vs the DUT/Mirror state to confirm that the RM and DUT/Mirror are in synchronization and have all the same values, i.e., the RM verifies the DUT state is correct.

If the DUT/Mirror state matches the RM:

The algorithm selects that path as the correct sequence of operations, discards all options, and replays the exact sequence of steps to get to that path down the tree.

The algorithm leaves the RM and DUT/Mirror in compared equal state.

If there is no match, the algorithm continues.

If the algorithm fails to find a match and exhausts all possible paths.

If all comparisons fail, then the DUT state is not considered permissible and the error is reported.

FIG. 8 shows an example of a speculative execution and synchronization algorithm operation.

### Divergence and Re-Convergence of DUT and RM

This is a technique to solve the problem where the DUT and RM are not the same, (often due to the speed of developing the DUT and RM as the design project evolves) and when performing lock step verification, something is flagged as incorrect and execution flows diverge very quickly in the program flow and hence verification cannot continue.

This difference between DUT and RM is often the case as a project evolves and due to development processes—for example, when the RM has new features that have not yet being implemented in the DUT—and so verification often stops—which delays projects.

What is desired is to flag the verification comparison failure (i.e. the divergence in program flow) and then by using values of the state of the DUT, update the state of the RM, ie force the RM state and thus the program, to continue and re-converge. We use the mirror for these DUT values.

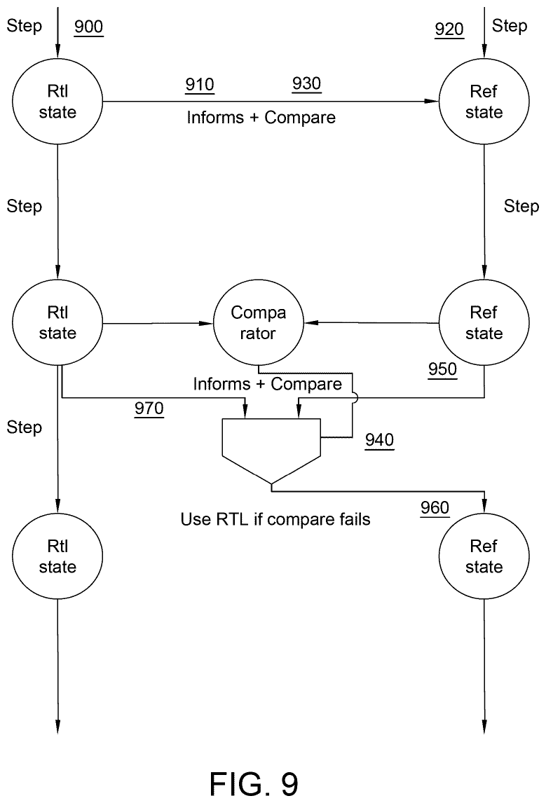

In an example of a re-convergence algorithm, in normal operation the Verification Control steps the DUT (rtl) 900, and then informs 910 the RM (ref) using the Mirror of its current state. The Verification Control then steps the RM (reg) 920. The Verification Control then initiates a compare of the DUT/Mirror state with RM state 930. If the compare fails then in normal operation there would be reporting and a finish of the verification run. With the re-convergence enabled, the failing of the comparison 940 does not terminate the verification run, but initiates an RM state update. So, in normal operation the RM state is used in the next step 950 but in re-convergence mode the RM takes on 960 the full state of the DUT/Mirror 970, reports the problem and continues as if everything had compared successfully. FIG. 9 shows an example of a re-convergence algorithm.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A method comprising:
loading a processor design under test (DUT), the DUT configured to execute instructions defined by an instruction set architecture (ISA);
loading and initializing an instruction accurate reference model (RM) that models a behaviour of the ISA regarding its instructions, register states, state machines and asynchronous events;
making a mirror that initially includes copies of data from the RM;
stepping the DUT and the RM forward in time to execute instructions from a test program, keeping the DUT and RM in lock-step in their execution of the instructions;
identifying, by a processing device, differences between data in the DUT and data in the RM, as the DUT and the RM execute instructions in lock-step; and
updating the mirror with data from the DUT as the DUT completes execution of instructions.

2. The method of claim 1, wherein identifying the differences between data in the DUT and data in the RM comprises: after the mirror is updated with data from the DUT, identifying the differences between data in the mirror and data in the RM.

3. The method of claim 1, wherein the RM models only the instructions defined by the ISA and not micro-operations in the DUT that implement such instructions.

4. The method of claim 1, wherein the DUT and the RM are stepped forward in time to execute one instruction at a time in lock-step.

5. The method of claim 4, wherein identifying differences between data in the DUT and data in the RM comprises comparing data in the DUT and data in the RM after the DUT and the RM complete execution of each instruction.

6. The method of claim 1, wherein updating the mirror with data from the DUT comprises:
updating the mirror with the DUT state;
checking that the DUT state is stored at correct locations in the mirror; and
checking that the mirror is updated with permissible values for the DUT state.

7. The method of claim 1, wherein:
registers in the DUT are identified as volatile if they are defined by micro-operations in the DUT but not by instructions in the ISA;
when the DUT executes an instruction that affects a volatile register, data in the RM is updated using data from the DUT.

8. The method of claim 7, wherein updating data in the RM using data from the DUT comprises: after the mirror is updated with data from the DUT, updating data in the RM using the updated data from the mirror.

9. A system comprising:
a memory storing instructions; and
a processing device, coupled with the memory and to execute the instructions, the instructions when executed cause the processing device to implement a testbench comprising:
a tracer interface to a processor design under test (DUT), the DUT configured to execute instructions defined by an instruction set architecture (ISA) and the tracer interface configured to inspect a state of the DUT;
an instruction accurate reference model (RM) that models a behaviour of the ISA regarding its instructions, register states, state machines and asynchronous events;
a mirror that initially includes copies of data from the RM; and
a verification control configured to:
step the DUT and the RM forward in time to execute instructions from a test program, keeping the DUT and RM in lock-step in their execution of the instructions;
identify differences between data in the DUT and data in the RM, as the DUT and the RM execute instructions in lock-step; and
update the mirror with data from the DUT as the DUT completes execution of instructions.

10. The system of claim 9, wherein the verification control comprises: verification components that control, record, manage, measure, check, and report verification runs that compare DUTs with RMs.

11. The system of claim 9, wherein the verification control is further configured to clock the execution of instructions by the DUT and the RM, keeping the DUT and RM in lock-step in their execution of the instructions.

12. The system of claim 9, wherein the testbench further comprises:
a DUT memory, wherein the test program is compiled into object code stored in the DUT memory for execution by the DUT; and
a RM memory, wherein the test program is compiled into object code stored in the RM memory for execution by the RM.

13. The system of claim 9, wherein the DUT is written in a hardware description language, and the verification control runs a simulation of the DUT written in the hardware description language.

14. The system of claim 9, wherein the DUT is implemented by configuring a field-programmable gate array (FPGA), and the verification control executes the instructions on the configured FPGA.

15. A non-transitory computer readable medium comprising stored instructions, which when executed by a processing device, cause the processing device to:
load a processor design under test (DUT), the DUT configured to execute instructions defined by an instruction set architecture (ISA);
construct an instruction accurate reference model (RM) that models a behaviour of the ISA regarding its instructions, register states, state machines and asynchronous events;
step the DUT and the RM forward in time to execute instructions from a test program, keeping the DUT and RM in lock-step in their execution of the instructions; and
identify differences between data in the DUT and data in the RM, as the DUT and the RM execute instructions in lock-step.

16. The non-transitory computer readable medium of claim 15, wherein the ISA includes different choices for implementation, and the RM is configurable to model the different choices.

17. The non-transitory computer readable medium of claim 15, wherein constructing the RM comprises: creating data structures for the RM based on a configuration file for the ISA and based on a configuration file for the DUT.

18. The non-transitory computer readable medium of claim 17, wherein the configuration file for the ISA contains base model information that is not specific to any DUT.

19. The non-transitory computer readable medium of claim 15, wherein the ISA is a standard.

20. The non-transitory computer readable medium of claim 15, wherein the instructions further cause the processing device to
make a mirror that initially includes copies of data from the RM; and
update the mirror with data from the DUT as the DUT completes execution of instructions.
